(19) United States
(12) Patent Application Publication
(10) Pub. No.: US 2008/0279600 A1
(43) Pub. Date: Nov. 13, 2008

(54) IMAGE FIXING APPARATUS AND IMAGE FORMING APPARATUS HAVING THE SAME

(75) Inventor: SEUNG-HAK HAN, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/055,557

(22) Filed: Mar. 26, 2008

(30) Foreign Application Priority Data
May 9, 2007 (KR) 2007-45150

(51) Int. Cl. G03G 15/00

(52) U.S. Cl. 399/400

(57) ABSTRACT

An image fixing apparatus and an image forming apparatus having the same, the image forming apparatus including: a main body, in which a conveyance path for a printing medium is formed; a first unit arranged on the conveyance path, a second unit arranged on the conveyance path, downstream from the first unit, with respect to a transferring direction of the printing medium, and a distance adjusting unit to open the first unit, according to an opening of the second unit.

### CROSS-REFERENCE TO RELATED APPLICATION

This application claims the benefit of Korean Application No. 2007-45150, filed May 9, 2007, in the Korean Intellectual Property Office, the disclosure of which is incorporated herein by reference.

### BACKGROUND OF THE INVENTION

1. Field of the Invention

An aspect of the present invention relates to an image forming apparatus to form an image on a printing medium.

2. Description of the Related Art

An image forming apparatus, and especially a multi-function image forming apparatus having various functions (such as, a copier, a printer, or a facsimile machine), mainly operates to visualize an input image signal onto a printing medium. An image forming apparatus generally includes a paper feeding part to feed printing medium, an image forming unit to form an image, a transfer unit to transfer the image onto a printing medium, an image fixing apparatus to fix the transferred image on the printing medium, and a discharge unit to discharge the printing medium to outside. Conventional examples of an image fixing unit 30 and a discharge unit 40 are illustrated in FIG. 1.

Referring to FIG. 1, the image fixing unit 30 and the discharge unit 40 are arranged in parallel, on a main body 10 of the image forming apparatus, across a transfer path of printing medium. The image fixing unit 30 is disposed upstream of the discharge unit 40 with respect to the movement of the printing medium along the transfer path. The image fixing unit 30 includes a pair of fixing rollers (not shown), which rotate in contact with each other, so as to form a nip area therebetween. The discharge unit 40 includes a discharge roller 41, which rotates to discharge the printing medium, and a discharge guide 42 to guide the printing medium along the transfer path.

In the above structure, an image is fixed to a printing medium, as the printing medium passes through the image fixing unit 30. The printing medium is then discharged from the main body 10 by the discharge unit 40.

The printing medium may become jammed, due to high temperatures and pressures of the image fixing unit 30. When the printing medium becomes jammed, a user rotates the discharge roller 41 to open the image fixing unit 30, and removes the jam (FIG. 1). Referring to FIG. 2, a distance adjustment lever 50, at one side of the image fixing unit 30, is operated to widen the interval between the two fixing rollers (not shown). Accordingly, a user can more easily see and remove the jammed printing medium.

Because the removal of the jam requires at least two operations, (rotating the discharge roller 41 and operating the distance adjustment lever 50 to open the image fixing unit 30), repair or maintenance of an image forming apparatus is difficult.

### SUMMARY OF THE INVENTION

Accordingly, the present general inventive concept has been made to solve the above-mentioned and/or other problems. An aspect of the present general inventive concept is to provide an image forming apparatus having an improved structure, which is capable of removing a jammed printing medium efficiently, by adjusting a distance between nip areas with simple manipulation.

According to an aspect of the present invention, there is provided an image forming apparatus including: a main body, in which a conveyance path for a printing medium is formed; a first unit arranged on the conveyance path; a second unit arranged on the conveyance path, downstream from the first unit with respect to the movement of the printing medium along the conveyance path, and a distance adjusting unit to adjust a distance between the first unit and the conveyance path. The second unit is movable with respect to the main body, so as to selectively open the first unit. The distance adjusting unit moves in association with the movement of the second unit.

According to one aspect of the present invention, the distance adjusting unit includes an interoperating part that is moved in association with the movement of the second unit, and a movable part to move the first unit according to the interoperating part.

The image forming apparatus, according to another aspect of the present invention, includes a pair of conveyance members provided on opposing sides of the conveyance path, to convey the printing medium. The pair of conveyance members rotate in contact with each other, so that nip areas are created therebetween. The distance adjusting unit adjusts a gap between the nip areas of the pair of first conveyance members.

According to yet another aspect of the present invention, the second unit includes: at least one second conveyance member to convey the printing medium; and a rotating member having a fixed end that is engaged with the main body of the image forming apparatus, and a free end that is rotatable about the fixed end.

According to yet another aspect of the present invention, the interoperating part is displaced by the rotation of the rotating member.

According to yet another aspect of the present invention, the interoperating part includes a rail provided on a side of the rotating member, a link provided on the main body of the image forming apparatus in a bi-directionally movable manner, and a link protrusion protruding from the link, and inserted in the rail.

According to yet another aspect of the present invention, the movable part includes: a first lever engaged with the link, via a first shaft; a second lever engaged with the first lever, via a second shaft; a movable protrusion engaged with a third shaft, which fixes one end of the second lever to the main body of the image forming apparatus, so as to be moved by the movement of the second lever; and a support member to support one of the pair of first conveyance members, and which is engaged with the main body, via a fourth shaft, to be moved by the movable protrusion.

According to yet another aspect of the present invention, the support member includes a seating recess on which the movable protrusion is selectively seated.

According to yet another aspect of the present invention, the first unit is a fixing unit to fix a transferred image onto the printing medium. The second unit is a discharge unit to discharge the printing medium out of the main body.

According to yet another aspect of the present invention, the pair of first conveyance members comprise: a heating roller heated by a heating source; a pressing roller supported by a spring; and a distance adjusting unit to move along a rotation shaft of the pressing roller.

According to yet another aspect of the present invention, an image forming apparatus includes: a main body housing an image forming part; an image fixing unit including a pair of image fixing rollers, to fix an image onto a printing medium; a discharge unit to discharge the printing medium out of the main body, and to selectively open the image fixing unit; and a distance adjusting unit to adjust a distance between the pair of image fixing rollers, by the operation of the discharge unit.

According to yet another aspect of the present invention, the distance adjusting unit includes an interoperating part that moves in association with the discharge unit, and a movable part to move at least one of the pair of image fixing rollers, in accordance with the interoperating part.

According to yet another aspect of the present invention, the discharge unit includes a discharge roller, and a discharge guide having a fixed end engaged with the main body, and a free end rotatable about the fixed end. The interoperating part is displaced by the rotation of the discharge guide.

According to yet another aspect of the present invention, the interoperating part includes a rail provided on a side of the discharge guide, a link provided on the main body in a bi-directionally movable manner, and a link protrusion protruding from the link, and inserted in the rail.

According to yet another aspect of the present invention, the movable part includes: a first lever engaged with the link, via a first shaft; a second lever engaged with the first lever, via a second shaft; a movable protrusion engaged with a third shaft, which fixes one end of the second lever to the main body, so as to be moved by the movement of the second lever; and a support member to support at least one of the pair of image fixing rollers, which is engaged with the main body, via a fourth shaft that is moved by the movable protrusion.

According to yet another aspect of the present invention, an image fixing apparatus of an image forming apparatus, includes: a pair of image fixing rollers; a housing to support the pair of image fixing rollers; a cover member rotatably provided on the housing, to selectively open the pair of image fixing rollers; and a distance adjusting unit to adjust a distance between the pair of image fixing rollers, according to the movement of the cover member.

According to yet another aspect of the present invention, the distance adjusting unit includes an interoperating part to move in association with the cover member, and a movable part to move at least one of the pair of image fixing rollers, according to the movement of the interoperating part.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a perspective view of a conventional image forming apparatus;

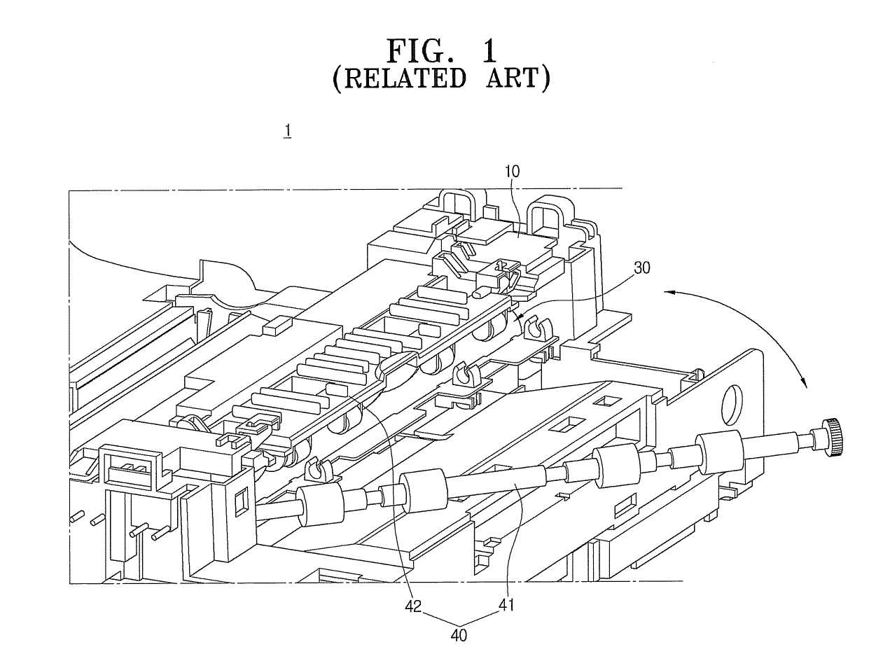

FIG. 2 is a rear perspective view of the image forming apparatus of FIG. 1;

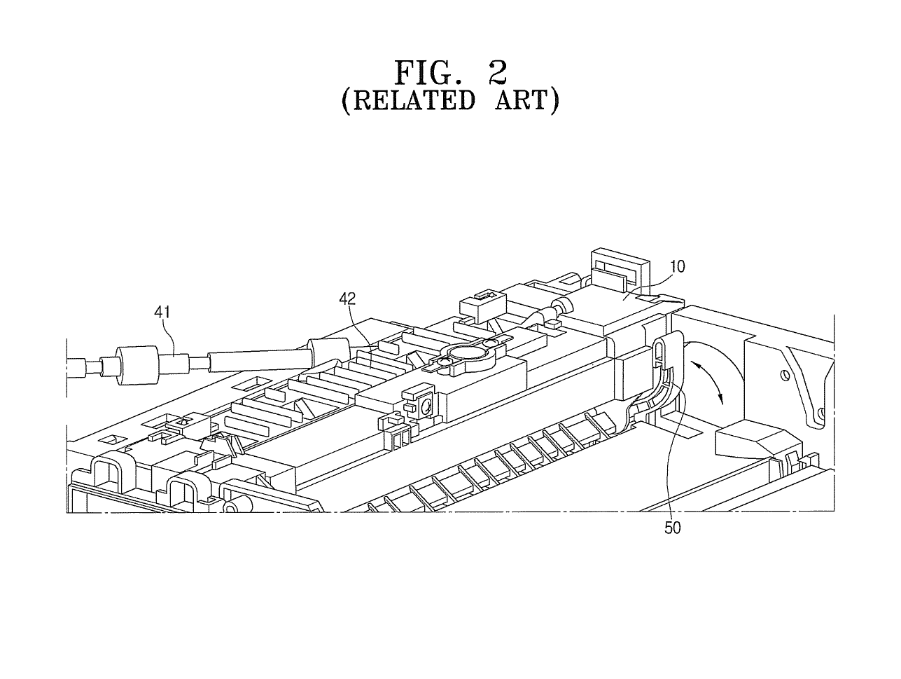

FIG. 3 schematically illustrates the structure of an image forming apparatus according to an exemplary embodiment of the present invention;

FIG. 4 is an enlarged perspective view illustrating an image fixing unit, a discharge unit, and a distance adjusting unit, according to exemplary embodiments of the present invention; and

FIGS. 5 and 6 are cross sectional views to explain an operation of adjusting a distance, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

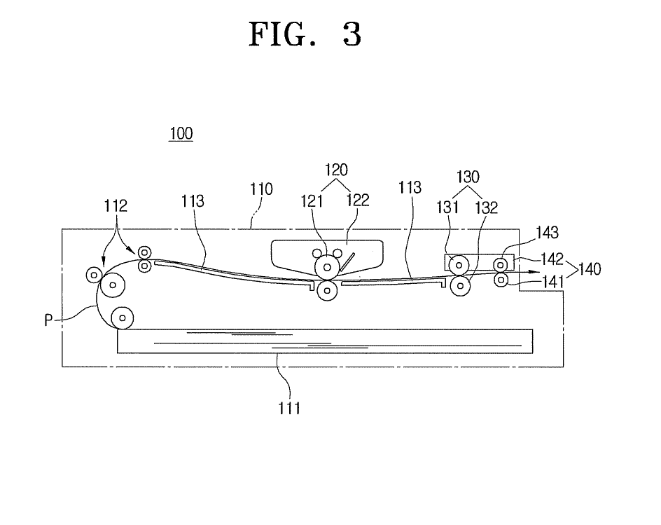

Referring to FIG. 3, an image forming apparatus 100, according to an exemplary embodiment of the present invention, includes a main body 110, an image forming part 120, fixing unit 130, a discharge unit 140, and a distance adjusting unit 150. While not required, the image forming apparatus 100 can be a stand alone printer, or be included in a multifunctional device having copying, scanning, and/or faxing capabilities.

The main body 110 supports a series of components to print an image on a printing medium P. A paper cassette 111 stores sheets of the printing medium P. and is detachably mounted on the main body 110. A plurality of conveyance rollers 112 and conveyance guides 113 form a conveyance path inside the main body 110. The printing medium P is transferred along the conveyance path in a transfer direction.

The image forming part 120 is disposed inside the main body 110, to form an image onto the printing medium P from the paper cassette 111. The image forming part 120 includes a photoconductive medium 121, on which an electrostatic latent image is formed, and a developing machine 122 to develop the electrostatic latent image. The image forming part 120 can have any conventional structure, therefore, it will not be explained in detail. However, it is understood that the image forming part 120 can be used for single color or multicolor printing.

Referring to FIG. 3, an image formed on the printing medium P as the printing medium P passed through the image forming part 120. The image fixing unit 130 heats and presses the printing medium P, to fix the image into the printing medium P. The image fixing unit 130 includes a heating roller 131 and a pressing roller 132. The heating roller 131 includes a heating source (not shown), which heats the heating roller 131 to a fixing temperature. The heating source (not shown) may be implemented as a variety of heating bodies, examples including a halogen lamp, a heating coil, or a resistive heating body.

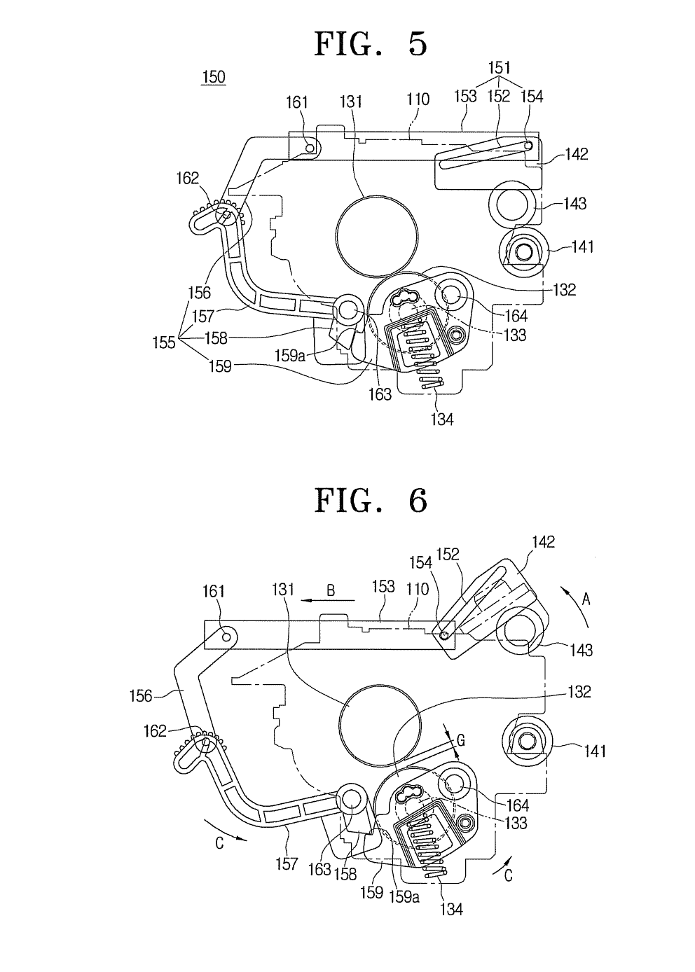

Referring to FIGS. 3 and 5, the pressing roller 132 has a rotation shaft 133 that protrudes from opposite ends thereof. The protruding ends of the shaft 133 are biased toward the heating roller 131, by a spring 134. Accordingly, a nip area is formed between the pressing roller 132 and the heating roller 131. The spring 134 can be, for example, a standard coil spring. However, any other suitable biasing device can be used in addition to, or instead of, the spring 134.

The heating roller 131 or the pressing roller 132 can be actively driven, by a driving force transmitted from a driving source (not shown), and the rotation of the driven roller can be passively applied, to rotate the other roller. However, the above example is not limiting. Alternatively, both the heating roller 131 and the pressing roller 132 may be actively driven.

The discharge unit 140 discharges a printing medium P, on which an image is fixed, from the main body 110. The discharge unit 140 is arranged adjacent to the image fixing unit 130. The discharge unit 140 includes at least one discharge roller 141 and discharge guide 142, to guide the printing medium P. The discharge can be to an external tray or holder.

The image fixing unit 130 and the discharge unit 140 may be implemented as a first and second units, in which the first unit is disposed upstream and the second unit is disposed downstream with respect to a direction in which the printing medium P is conveyed. In this case, the heating roller 131 and the pressing roller 132, as a pair, constitute a first conveyance member to convey the printing medium P, and said at least one discharge roller 141 constitutes a second conveyance member.

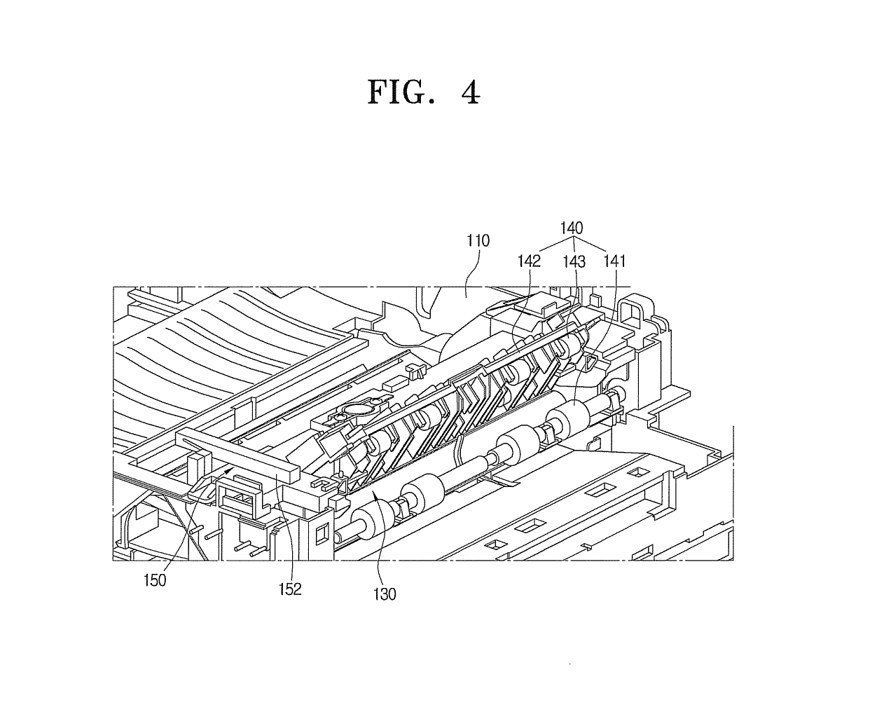

Affixed end of the discharge guide 142 has a fixed end attached to the main body 110, and an opposing free end that is capable of rotating about the fixed end. The discharge guide includes a rail 152, which is disposed at a predetermined inclination, between the free end and the fixed end. Referring to FIGS. 4 and 6, the discharge guide 142 selectively opens the image fixing unit 130, by rotating along direction A. That is, the discharge guide 142 is rotatably disposed in the main body, to operate also as the cover member to selectively open the heating roller 131 and the pressing roller 132. The discharge guide 142 includes a guide roller 143, to guide the discharge of the printing medium P.

Referring to FIGS. 5 and 6, the distance adjusting unit 150 is moved in association with the movement of the discharge guide 142, to adjust the distance between the image fixing unit 130 and the conveyance path. That is, to adjust a nip gap G between the heating roller 131 and the pressing roller 132. The distance adjusting unit 150 includes an interoperating part 151, and a movable part 155.

The interoperating part 151 operates in association with the movement of the discharge guide 142. The shown interoperating part 151 includes a link 153, and a link protrusion 154. The link protrusion 154 is disposed in the rail 152, so as to slide along the rail 152. However, it is understood that the rail 152 can be included in the interoperating part 151 and the protrusion 154 can be included in the guide 142 in other exemplary embodiments.

Referring to FIG. 6, the link 153 is disposed on the main body 110, and is movable along direction B. Although not shown in detail, part of the link 153 is generally inserted in a guide groove (not shown) formed in the main body 110, to enable a horizontal movement (in direction B) of the link 153. However, other mechanisms can be used to allow such movement and the movement can be in other linear and nonlinear directions in various exemplary embodiments.

The link protrusion 154 protrudes from the link 153, and is inserted in the rail 152. As the link protrusion 154 moves along the rail 152, in accordance with movements of the discharge guide 142.

The movable part 155 adjusts nip gap G, between the heating roller 131 and the pressing roller 132, due to the movement of the interoperating part 151, which subsequently moves the image fixing unit 130. Referring to FIGS. 5 and 6, the movable part 155 includes a first lever 156, a second lever 157, a movable protrusion 158, and a support member 159.

The first lever 156 is engaged with a first shaft 161 provided on the link 153. Because the first lever 156 is engaged with the link 153, via the first shaft 161, the first lever 156 is moved in direction C, according to the movement of the link 153.

The second lever 157 is engaged with the first lever 156, via a second shaft 162. The second lever 157 moves in direction C, according to the movement of the first lever 156. The movable protrusion 158 is engaged with a third shaft 163, which fixes one end of the second lever 157 to the main body 110. The movable protrusion 158 is moved in direction C, according to the movement of the second lever 157. The movable protrusion 158 is rotated, according to the rotational angle of the second lever 157. The movable protrusion 158 may be integrally formed with the second lever 157.

The support member 159 supports the rotation shaft 133 of the pressing roller. The support member 159 is engaged with the main body 110, via a fourth shaft 164, so as to be moved by the movable protrusion 158. Referring to FIG. 6, the support member 159 is moved in direction C, by the movable protrusion 158, widening the nip gap G between the heating roller 131 and the pressing roller 132.

Referring to FIG. 6, the support member 159 includes a seating recess 159a, where the movable protrusion 158 is selectively seated. The first and second shafts 161 and 162 connect the first lever 156 to the link 153 and the second lever 157, and are not fixed to the main body 110. The third and fourth axes 163 and 164 are fixed to the main body 110.

The operation of adjusting the nip gap G, in an image forming apparatus 100, according to the exemplary embodiments of the present invention, will be explained below with reference to FIGS. 3 to 6. Referring to FIG. 3, a printing medium P is fed from the paper cassette 111, conveyed along the conveyance roller 112, and enters into the image forming part 120, where an image is formed on the printing medium P. The image is fixed to the printing medium, by the heat and pressure from the heating roller 131 and the pressing roller 132, of the image fixing unit 130. After the image is fixed, the printing medium P is conveyed by the discharge roller 141 along the discharge guide 142, to be discharged from the main body 110.

If an error occurs during a conveyance of a printing medium P. for example, the printing medium P is jammed between the heating roller 131 and the pressing roller 132, referring to FIGS. 4 and 6, the user rotates the discharge guide 142 in direction A. Accordingly, a user is able to see the jammed printing medium P. between the heating roller 131 and the pressing roller 132.

According to the rotation of the discharge guide 142 in direction A, the link protrusion 154 is moved along the rail 152 of the discharge guide 142, in direction B. The rail 152 is also moved in direction B.

According to the movement of the rail 152 in direction B, the first lever 156, which is engaged with the rail 152, via the first shaft 161, and the second lever, which is engaged with the first lever 156, via the second shaft 162, and is fixed to the main body 110, via the third shaft 163, are rotated in direction C.

The movable protrusion 158, is moved about the third shaft 163, by the second lever 157, according to the rotation of the second lever 157 in direction C. The protrusion 158 rotates the support member 159 in direction C. The protrusion 158 is seated on the seating recess 159a formed in the support member 159.

When the support member 159 is rotated in direction C, the rotation shaft 133 of the pressing roller 132, which is supported by the support member 159, is also rotated in direction C. The spring 134 is compressed, to widen nip gap G between the heating roller 131 and the pressing roller 132.

The user is able to see the printing medium P jammed between the heating roller 131 and the pressing roller 132, and can easily remove the jammed printing medium P, without having to perform additional operations.

After removing the jammed printing medium P. the user returns the discharge guide to its original position (FIG. 5). The interoperating part 151 and the movable part 155 are returned to their original positions, according to the movement of the discharge guide 142. Therefore, the heating roller 131 and the pressing roller 132 are squeezed together, creating a nip area therebetween, so as to be ready for the next printing process.

In the above exemplary embodiments of the present invention, the operation of adjusting the distance is exemplified by adjusting a nip gap between the heating roller 131 and the pressing roller 132, of the image fixing unit 130. However, the above is not limiting. For example, the distance adjusting unit 150 may adjust the distance between two components in contact with each other, such as, a distance between the photoconductive medium 121 and the developing machine 122, a distance between the photoconductive medium 121 and the transfer medium, or a distance between a pair of the conveyance rollers 112. Moreover, while a specific example of a transmission system is shown with respect to elements 151-159, it is understood that the distance adjusting unit 150 can utilize other systems in other exemplary embodiments.

As explained above, in the exemplary embodiments of the present invention, a distance between the heating and pressing rollers is adjusted by rotating a discharge guide, so that a jammed printing medium can be removed by one manipulation. Accordingly, a user-friendly image forming apparatus, which is easy to repair and maintain, is provided.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. An image forming apparatus, comprising:
a main body having a conveyance path to transfer a printing medium;
a first unit arranged on the conveyance path;
a second unit arranged on the conveyance path, downstream from the first unit with respect to a transfer direction of the printing medium; and
a distance adjusting unit to open the first unit, in accordance with an opening of the second unit.

2. The image forming apparatus of claim 1, wherein the distance adjusting unit comprises:
an interoperating part connected to the first unit; and
a movable part connected to the interoperating part and the second unit,
wherein the interoperating part moves the moveable part to open the first unit, according to the opening of the second unit.

3. The image forming apparatus of claim 2, wherein the first unit comprises a pair of conveyance members provided on opposing sides of the conveyance path to convey the printing medium, the pair of conveyance members rotate in contact with each other so that nip areas are created therebetween, and wherein
the distance adjusting unit adjusts a gap between the nip areas of the pair of first conveyance members.

4. The image forming apparatus of claim 3, wherein the second unit comprises:
a discharge roller to discharge the printing medium from the main body; and
a discharge guide having a fixed end engaged with the main body and a free end to rotate around the fixed end.

5. The image forming apparatus of claim 4, wherein the interoperating part moves according to the rotation of the discharge guide.

6. The image forming apparatus of claim 5, wherein the interoperating part comprises:
a rail attached to a side of the discharge guide;
a link having a protrusion disposed in the rail, slidably attached to the main body in a bi-directionally movable manner

7. The image forming apparatus of claim 6, wherein the movable part comprises:
a first lever engaged with the link, via a first shaft;
a second lever engaged with the first lever, via a second shaft;
a movable protrusion engaged with a third shaft that fixes one end of the second lever to the main body, such that the moveable protrusion is moved, according to a movement of the second lever; and
a support member engaged with the main body, via a fourth shaft, to move the pressing roller, according to the movement of the movable protrusion.

8. The image forming apparatus of claim 7, wherein the support member comprises a seating recess on which the movable protrusion is seated when the first unit is opened.

9. The image forming apparatus of claim 1, wherein the first unit is an image fixing unit to fix an image onto the printing medium, and the second unit is a discharge unit to discharge the printing medium from the image fixing unit, out of the main body.

10. The image forming apparatus of claim 9, wherein the pair of first conveyance members comprise a heating roller heated by a heating source and a pressing roller supported by an elastic spring, and the distance adjusting unit moves a rotation axis of the pressing roller.

11. An image forming apparatus, comprising:
a main body housing an image forming part;
an image fixing unit comprising image fixing rollers, to fix an image onto a printing medium;
a discharge unit to discharge the printing medium from the image fixing unit, out of the main body; and
a distance adjusting unit to adjust a distance between the image fixing rollers, according to an opening of the discharge unit.

12. The image forming apparatus of claim 11, wherein the distance adjusting unit comprises:
an interoperating part to move according to the opening of the discharge unit; and
a movable part to move one of the image fixing rollers, according to the movement of the interoperating part.

13. The image forming apparatus of claim 12, wherein the discharge unit comprises:
a discharge roller; and
a discharge guide having a fixed end engaged with the main body, a free end to rotate about the fixed end, to move the interoperating part, and a rail.

14. The image forming apparatus of claim 13, wherein the interoperating part comprises:
a link disposed on the main body, to move substantially linearly, according to the rotation of the discharge guide; and
a link protrusion protruding from the link and slidably inserted in the rail.

15. The image forming apparatus of claim 14, wherein the movable part comprises:
a first lever engaged with the link, via a first shaft;
a second lever engaged with the first lever, via a second shaft;
a movable protrusion engaged with a third shaft that fixes one end of the second lever to the main body, such that the protrusion is moved, according to a movement of the second lever; and
a support member engaged with the main body, via a fourth shaft, to move one of the image fixing rollers, according to the movement of the movable protrusion.

16. The image forming apparatus of claim 15, wherein the support member comprises a seating recess, on which the movable protrusion is seated when the image fixing unit is opened.

17. The image forming apparatus of claim 11, wherein:
the image fixing rollers comprise,
a heating roller to heat the printing medium; and
a pressing roller comprising a rotation shaft, biased against the heating roller; and
the distance adjusting unit moves the rotation shaft to adjust the distance.

18. An image fixing apparatus of an image forming apparatus, comprising:
image fixing rollers;
a housing to support the image fixing rollers;
a cover member rotatably provided on the housing, to selectively open the pair of image fixing rollers; and
a distance adjusting unit to adjust a distance between the image fixing rollers, according to the rotation of the cover member.

19. The image fixing apparatus of claim 18, wherein the distance adjusting unit comprises:
an interoperating part to move according to the movement of the cover member; and
a movable part to move at least one of the image fixing rollers, according to the movement of the interoperating part.

20. The image fixing apparatus of claim 19, wherein the interoperating part comprises:
a link provided on the housing, to move substantially linearly, according to the rotation of the cover member; and
a link protrusion protruding from the link and inserted into a rail of the cover member.

21. The image fixing apparatus of claim 20, wherein the movable part comprises:
a first lever engaged with the link, via a first shaft;
a second lever engaged with the first lever, via a second shaft;
a movable protrusion engaged with a third shaft that fixes one end of the second lever to the housing, such that the protrusion is moved, according to a movement of the second lever; and
a support member engaged with the housing, via a fourth shaft, to move one of the image fixing rollers, according to the movement of the movable protrusion.

22. The image fixing apparatus of claim 18, wherein:
the fixing rollers comprise,
a heating roller to heat a printing medium, and a pressing roller comprising a rotation shaft, biased toward the heating roller; and
the distance adjusting unit moves the rotation shaft to adjust the distance.

23. A distance adjusting system of an image forming apparatus, comprising:
a discharge guide to open a discharge unit;
an interoperating link to move along a rail of the discharge guide of the image forming apparatus, according to movements of the discharge guide; and
a movable part to open an image fixing unit of the image forming apparatus, according to the movements of the interoperating link.

24. The system of claim 23, wherein the moveable part comprises:
a first lever attached to the interoperating link, to move according to the movements of the interoperating link;
a second lever attached to the first lever, to move according to the movements of the first lever; and
a protrusion to attached to the second lever, to open the image fixing unit, by rotating according to the movements of the second lever.

25. The system of claim 23, wherein:
the opening of the discharge unit comprises separating a guide roller and a pressing roller of the discharge unit; and
the opening of the image fixing unit comprises separating a heating roller and a pressing roller of the image fixing unit.
